(19) United States
(12) Patent Application Publication
(10) Pub. No.: US 2026/0339356 A1
(43) Pub. Date: Oct. 29, 2026

(54) MOBILE MACHINE DISPATCHING METHOD, ELECTRONIC DEVICE, AND COMPUTER-READABLE STORAGE MEDIUM

(71) Applicants: SHENZHEN YOUBIXING TECHNOLOGY CO., LTD, Shenzhen (CN); UBTECH ROBOTICS CORP LTD, Shenzhen (CN)

(72) Inventors: XINQI ZHOU, Shenzhen (CN); Xuancong Li, Shenzhen (CN); YouLian Long, Shenzhen (CN); Chuihua Dai, Shenzhen (CN)

(21) Appl. No.: 19/437,385

(22) Filed: Dec. 31, 2025

(30) Foreign Application Priority Data
Apr. 23, 2025 (CN) 202510517784.3

(51) Int. Cl. G05D 1/698; G05D 1/246; G05D 1/644

(52) U.S. Cl. CPC G05D 1/6987; G05D 1/2464; G05D 1/644

(57) ABSTRACT

A mobile machine dispatching method, an electronic device, and a computer-readable storage medium are provided. The method includes: searching for dispatching paths of mobile machines in descending order of priorities of the mobile machines; updating a passing cost of one of a plurality of channels in response to finding the dispatching path of the n-th mobile machine passing through said one of the plurality of channels; obtaining the dispatching path of the (n+1)-th mobile machine by performing a path planning on the (n+1)-th mobile machine based on the updated passing cost of said one of the plurality of channels and the passing costs of the rest channels; and controlling the mobile machines to move, according to the dispatching paths. In this manner, the overall traffic efficiency of the mobile machines when passing through the channels can be improved.

### CROSS REFERENCE TO RELATED APPLICATIONS

The present disclosure claims priority to Chinese Patent Application No. 202510517784.3, filed Apr. 23, 2025, which is hereby incorporated by reference herein as if set forth in its entirety.

### TECHNICAL FIELD

The present disclosure relates to path planning technology, and particularly to a mobile machine dispatching method, an electronic device, and a computer-readable storage medium.

### BACKGROUND

With the rapid development of robotics technology, robots have been brought from laboratories to practical applications, and are gradually being widely used in various complex scenarios such as automated warehouses, airport baggage handling, logistics distribution, and intelligent manufacturing. For example, in airport baggage handling, robots need to pass through access control facilities such as fare gates in high-flow environments to efficiently and accurately perform tasks such as baggage transportation. In which, dispatching algorithms, as the core algorithms of robotics technology, are used for determining the working order, path planning, and task allocation of robots in specific environments, thereby ensuring that the robots can operate efficiently and orderly in complex and ever-changing environments. However, in related technologies, in the case that there are many robots passing through gates, congestions are easily occurred.

### BRIEF DESCRIPTION OF DRAWINGS

FIG. 1 is a schematic diagram of the architecture of a mobile machine dispatching system according to an embodiment of the present disclosure.

FIG. 2 is a schematic diagram of the structure of an electronic device for mobile machine dispatching according to an embodiment of the present disclosure.

FIG. 3A is a flow chart of a mobile machine dispatching method according to the first embodiment of the present disclosure.

FIG. 3B is a flow chart of a mobile machine dispatching method according to the second embodiment of the present disclosure.

FIG. 3C is a flow chart of a mobile machine dispatching method according to the third embodiment of the present disclosure.

FIG. 3D is a flow chart of a mobile machine dispatching method according to the fourth embodiment of the present disclosure.

FIG. 4A is a schematic diagram of a mobile machine dispatching method according to the first embodiment of the present disclosure.

FIG. 4B is a schematic diagram of a mobile machine dispatching method according to the second embodiment of the present disclosure.

FIG. 4C is a schematic diagram of a mobile machine dispatching method according to the third embodiment of the present disclosure.

FIG. 4D is a schematic diagram of a mobile machine dispatching method according to the fourth embodiment of the present disclosure.

FIG. 5A is a schematic diagram of a mobile machine dispatching method according to the fifth embodiment of the present disclosure.

FIG. 5B is a schematic diagram of a mobile machine dispatching method according to the sixth embodiment of the present disclosure.

FIG. 5C is a schematic diagram of a mobile machine dispatching method according to the seventh embodiment of the present disclosure.

FIG. 5D is a schematic diagram of a mobile machine dispatching method according to the eighth embodiment of the present disclosure.

FIG. 6 is a flow chart of a mobile machine dispatching method according to the fifth embodiment of the present disclosure.

FIG. 7 is a flow chart of a mobile machine dispatching method according to the sixth embodiment of the present disclosure.

FIG. 8 is a schematic diagram of a mobile machine dispatching method according to the nineth embodiment of the present disclosure.

### DETAILED DESCRIPTION

In order to make the purpose of the present disclosure more clear, the technical solutions and advantages will be described in detail below in conjunction with the drawings. The described embodiments should not be regarded as limitations of the present disclosure, and all other embodiments obtained by those skilled in the art without creative work are within the protection scope of the present disclosure.

In the following descriptions, “some embodiments” are involved, which describe a subset of all possible embodiments, but it should be noted that “some embodiments” may be the same subset or different subset of all possible embodiments, which may be combined with each other when there is no conflict.

In the following descriptions, the involved terms “first”, “second”, “third”, and the like are merely for differentiating similar objects and do not represent a specific order for the objects. It should be noted that the specific order or sequence of “first”, “second”, “third”, and the like may be interchanged under certain conditions so that the embodiments of the present disclosure described herein may be implemented in an order other than those illustrated or described herein.

In the embodiments of the present disclosure, the term “module” or “unit” refers to a computer program or a part of a computer program with predetermined functions and works with other related parts to achieve predetermined goals and may be implemented in whole or in part by using software, hardware (e.g., processing circuit or storage) or a combination thereof. Similarly, a processor (or a plurality of processors or storages) may be used to implement one or more modules or units. In addition, each module or unit may be part of an integral module or unit containing the functions of the module or unit.

Unless otherwise defined, all technical and scientific terms used in the embodiments of present disclosure have the same meaning as commonly understood by those skilled in the art. The terms used in the embodiments of present disclosure are merely for describing the embodiments of present disclosure, not for limiting the present disclosure.

In the embodiments of the present disclosure, the relevant data collection and processing should be strictly based on the requirements of relevant laws and regulations and obtain the informed consent or separate consent of the subject of personal information, and should carry out subsequent data use and process within the scope of the authorization of laws, regulations, and the subject of personal information.

Before further detailed description of the embodiments of the present disclosure, the involved nouns and terms will be described as follows.
1) Grid map: a grid map is a map representation method that divides a geographic space into regular grid cells, which makes geographic data processing and analysis more efficient and intuitive by discretizing a continuous space into small cells, grid maps. Grid maps are widely used in fields including Geographic Information Systems (GIS), robot navigation, and environmental science, and can be used to represent various geographic features including terrain elevation, land use type, accessibility, and the like.
2) Grid: a grid is a structure that divides a geographic space into regular cells (usually squares or rectangles). Each cell contains one or more attribute values to describe the geographic features or states of the geographic space. In robot navigation, grid maps help robots with path planning and environmental perception by marking the accessibility of cells (e.g., accessible or obstacles). Due to their simple structure and ease of processing and computation, grids are widely used for the storage, analysis, and visualization of spatial data.
3) Channel: a channel is a common access control facility widely used in scenes where the flow of people or equipment needs to be managed, which has the main function for controlling the flow of people or equipment, thereby ensuring safety and order. The channel may be a gate, a tunnel, or the like.

The embodiments of the present disclosure provide a mobile machine dispatching method, an electronic device, and a computer-readable storage media, which can improve the overall traffic efficiency of mobile machines when passing through channels.

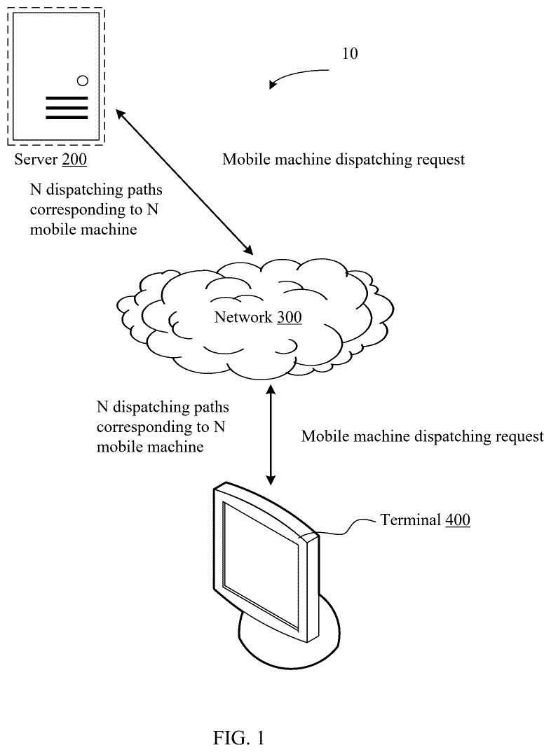

FIG. 1 is a schematic diagram of the architecture of a mobile machine dispatching system according to an embodiment of the present disclosure. As shown in FIG. 1, in this embodiment, in order to support a mobile machine dispatching application, a terminal 400 connects to a server 200 through a network 300 that may be a wide area network, a local area network, or a combination of the two.

In some embodiments, a mobile machine dispatching plug-in may be installed in a client executed in the terminal 400 so as to implement a mobile machine dispatching method locally on the client by, for example, making the terminal 400 to call the mobile machine dispatching plug-in so as to implement the mobile machine dispatching method. According to the order of priorities from high to low, the dispatching paths of N mobile machines (e.g., vehicles, wheeled robots, or humanoid robots) are searched sequentially. If the dispatching path of the searched n-th mobile machine passes through any of the M channels, the passing cost of the passed channel is updated. Based on the updated passing cost of the passed channel and the passing costs of the other M−1 channels, a path planning may be performed for the (n+1)-th mobile machine to obtain the dispatching path of the (n+1)-th mobile machine, thereby controlling the N mobile machines to move according to the corresponding N dispatching paths.

The terminal 400 may be used to obtain a mobile machine dispatching request that carries device priorities of the N mobile machines.

In some embodiments, after obtaining the mobile machine dispatching request, the terminal 400 may call a mobile machine dispatching interface (which may be provided as a cloud service) of the server 200. The server 200 implements the mobile machine dispatching method through the mobile machine dispatching plug-in by parsing the mobile machine dispatching request to obtain the device priorities of the N mobile machines. Based on the order of the device priorities from high to low, the dispatching paths of the N mobile machines are searched in sequence. If the searched dispatching path of the n-th mobile machine passes through any of the M channels, the passing cost of the passed channel is updated. Based on the updated passing cost of the passed channel and the passing costs of the other M−1 channels, the path planning for the (n+1)-th mobile machine is performed on the (n+1)-th mobile machine to obtain the dispatching path of the (n+1)-th mobile machine. The N dispatching paths corresponding to the N mobile machines are returned to the terminal 400, so that the terminal 400 controls the N mobile machines to move according to the corresponding N dispatching paths, respectively.

In some embodiments, the server 200 may be a stand-alone physical server, or a server cluster or distributed system composed of multiple physical servers, or may also be a cloud server providing cloud service, cloud database, cloud computing, cloud function, cloud storage, network service, cloud communication, middleware service, domain name service, security service, content delivery network (CDN), and basic cloud computing service such as big data and artificial intelligence platform. The terminal 200 and the electronic device 400 may be connected directly or indirectly through wired or wireless communication.

The terminal 400 may be a smartphone, a tablet computer, a notebook computer, a desktop computer, smart speaker, a smart watch, a smart speech interaction equipment, a smart home appliance, an in-car terminal, an aircraft, or the like. In this embodiment, the terminal 400 and the server 200 may be connected directly or indirectly through wired or wireless communication methods.

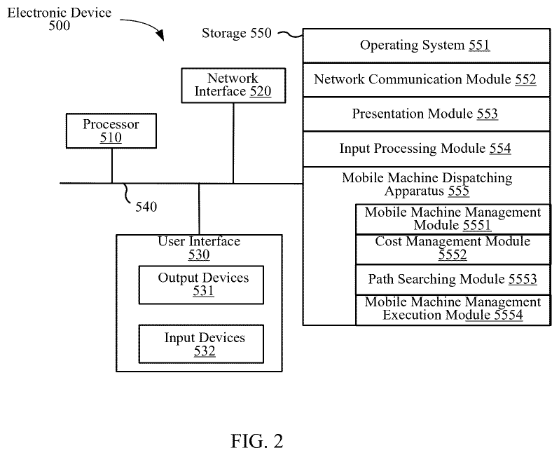

FIG. 2 is a schematic diagram of the structure of an electronic device 500 for mobile machine dispatching according to an embodiment of the present disclosure. As shown in FIG. 2, the electronic device 500 may be the terminal 400 or the server 200 in FIG. 1, which may include at least one processor 510, a storage 550, at least one network interface 520, and a user interface 530, where the foregoing components of the electronic device 500 are coupled together through a bus system 540 that is for realizing connection communication between the components. The bus system 540 may include, in addition to a data bus, a power bus, a control bus, and a status signal bus. Though, for clarity, the various buses are merely marked as the bus system 540 in FIG. 2.

The processor 510 may be an integrated circuit chip with signal processing capabilities, for example, a general-purpose processor, a digital signal processor (DSP), or other programmable logic device, discrete gate or transistor logic device, discrete hardware component, or the like. In which, the general-purpose processor may be a microprocessor, any conventional processor, or the like.

The user interface 530 may include one or more output devices 531 for presenting media contents, which may include one or more speakers and/or one or more visual displays. The user interface 530 may further include one or more input devices 532, which may include user interface components that facilitate user input, such as keyboard, mouse, microphone, touch screen display, camera, other input buttons and controls.

The storage 550 may be removable, non-removable, or a combination thereof. For example, the storage us may include solid state memory, hard disk drive, optical disk drive, or the like, and the storage us may optionally include one or more storage devices physically located away from the processor 510.

The storage 550 may include volatile memory, nonvolatile memory, or both. The nonvolatile memory may be read-only memory (ROM), and the volatile memory may be random access memory (RAM). In this embodiment, the storage 450 is intended to include any suitable type of storages.

In some embodiments, the storage 550 is able to store data to support various operations. The data may include, for example, programs, modules, data structures, or subsets or supersets thereof, as described below

An operating system 551 including system programs for processing various basic system services and performing hardware-related tasks, such as framework layer, core library layer, and driver layer, for realizing various basic services and processing hardware-based tasks.

A network communication module 552 configured to reach other computing devices via the (wired or wireless) network interfaces 520. For example, the network interface 520 may include Bluetooth, wireless compatibility authentication (Wi-Fi), universal serial bus (USB), and the like.

A presentation module 553 configured to present information through one or more output devices 531 (e.g., display screen and speaker) associated to the user interface 530 (e.g., user interface for operating peripherals and displaying content and information).

An input processing module 554 configured to detect and translate user inputs or interactions from the one or more input devices 532.

In some embodiments, the apparatus provided by the embodiments of the present disclosure may be implemented in software. As shown in FIG. 2, there is a mobile machine dispatching apparatus 555 stored in the storage 550, which may be a software in the form of program, plug-in, or the like that may include software modules namely a mobile machine management module 5551, a cost management module 5552, a path searching module 5553, and a mobile machine management execution module 5554. These modules are logical, so any combination or further disassembly may be performed according to the functions to be implemented. The functions of each module will be described below.

In some embodiments, the apparatus provided by the embodiments of the present disclosure may be implemented in hardware, and as an example, the apparatus may be a processor in the form of a hardware decoding processor that is programmed to execute the mobile machine dispatching method provided by the embodiments of the present disclosure. For example, the hardware decoding processor may adopt one or more application specific integrated circuits (ASICs), DSPs, programmable logic devices (PLDs), complex programmable logic devices (CPLDs), field-programmable gate arrays (FPGAs), or other electronic components.

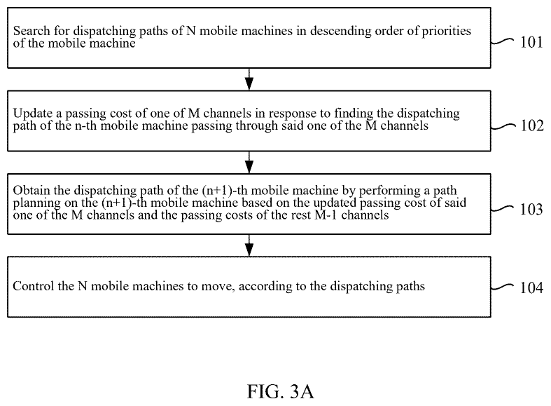

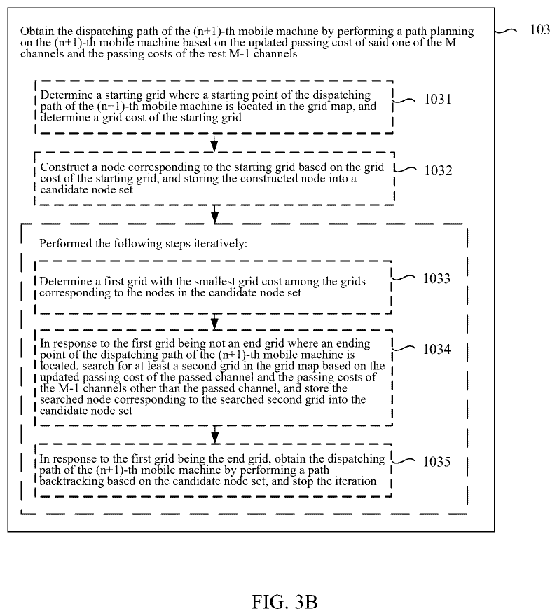

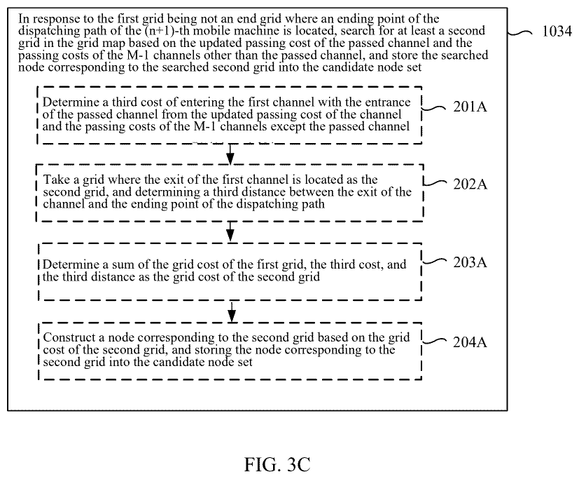

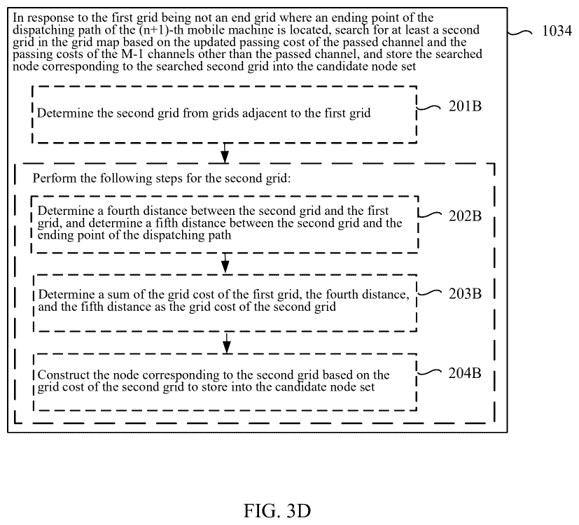

FIG. 3A is a flow chart of a mobile machine dispatching method according to the first embodiment of the present disclosure. In this embodiment, a mobile machine dispatching method is provided. The mobile machine dispatching method may be applied to (a processor of) the server 200 or the terminal 400 of the mobile machine dispatching system in FIG. 1. As mentioned above, the electronic device 500 in FIG. 2 that implements the mobile machine dispatching method may be the terminal 400, the server 200, or a combination of the two. Therefore, the subject of executing each step will not be described again below. As shown in FIG. 1, the mobile machine dispatching method may include the following steps

101: searching for dispatching paths of the N mobile machines in descending order of priorities of the mobile machines.

As an example, it may obtain the priority of the N mobile machines, and a starting point and an ending point of the dispatching path of each of the N mobile machines. According to the order of the priorities from high to low, it may search for the dispatching path of each mobile machine from its starting point to its ending point, where N is a positive integer larger than 1, and the mobile machine may be a wheeled equipment such as an Automatic Guided Vehicle (AGV), a food delivery robot, or a to building delivery robot that operates based on a raster map, or be a non-wheeled equipment such as drones that operates based on the raster map. The channel may be a gate, a tunnel, or the like.

The priority of each of the N mobile machines is different from that of the other mobile machines, and may be set in advance to consistent with, for example, the importance of the task executed by each mobile machine.

102: updating a passing cost of one of M channels in response to finding the dispatching path of the n-th mobile machine passing through said one of the M channels.

In which, the passing cost of the passed channel is the cost of passing the passed channel, Mis a positive integer larger than 1, n is a positive integer that increases sequentially, and 1≤n<N.

As an example, it may obtain the openings (each including an entrance and an exit) of the M channels and the passable direction of each channel. The channels include one-way channels and two-way channels. A one-way channel has a corresponding passable direction. The passing cost of a one-way channel is the cost of passing the one-way channel in the passable direction of the one-way channel. A two-way channel has two corresponding passable directions. The passing costs of the two-way channel include the cost of passing the two-way channel in one of the passable directions of the two-way channel, and that of passing the two-way channel in the other passable direction of the two-way channel.

In the case that the searched dispatching path of the n-th mobile machine passes through any of the M channels and the passed channel is a one-way channel, the passable direction of the passed channel is the first direction, that is, the direction through which the dispatching path of the n-th mobile machine passes the passed channel, and the passing cost of the passed channel is the first cost of passing the one-way channel in the first direction. The first cost of the channel is updated.

Otherwise, in the case that the searched dispatching path of the n-th mobile machine passes through any of the M channels and the passed channel is a two-way channel, the passable direction of the passed channel includes the first direction, that is, the direction through which the dispatching path of the n-th mobile machine passes the passed channel, and the passing cost of the passed channel includes the first cost of passing the passed channel in the first direction. The first cost is updated. The passable direction of the passed channel further includes the second direction, and the passing cost of the passed channel further includes the second cost of passing the passed channel in the second direction. The second cost is updated.

In some embodiments, if a direction through which the dispatching path of the n-th mobile machine passes the channel is a first direction, the passing cost of the channel includes a first cost of passing through the channel in the first direction, and the “updating the passing cost of one of the plurality of channels” in step 102 of FIG. 3A may include: determining a first distance between a starting point of the dispatching path of the n-th mobile machine and an entrance of the passed channel; and increasing the first cost based on the first distance, and taking the increased first cost as an updated first cost.

In which, the channel may be a one-way channel or a two-way channel, and the first direction is from the entrance of the channel to an exit of the passed channel.

As an example, it may determine the first distance between the starting point of the dispatching path of the n-th mobile machine and the entrance of the channel and the first speed of the n-th mobile machine in the area outside the channel, and determine the ratio of the first distance to the first speed as a first time duration required for the n-th mobile machine to reach the entrance of the passed channel from the starting point of the dispatching path. It may further determine the mobile machine that has the priority lower than the n-th mobile machine and passes through the passed channel in the first direction as the 1-st device, and take the product of the first time duration and the movement speed of the 1-st device in the area outside the passed channel as the increment of the first cost, then take the sum between the first cost and the increment of the first cost as the updated first cost.

In the case that the movement speeds of the N mobile machines in the area outside the passed channel are all consistent as the first speed, the increment of the first cost is numerically equivalent to the first distance, and the sum of the first cost and the first distance is taken as the updated first cost, which will be explained below.

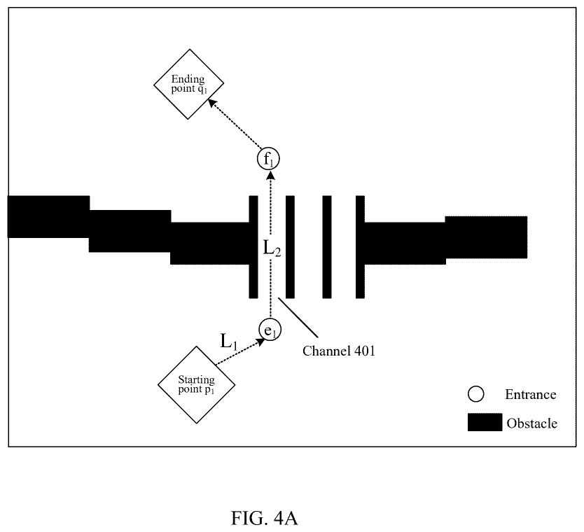

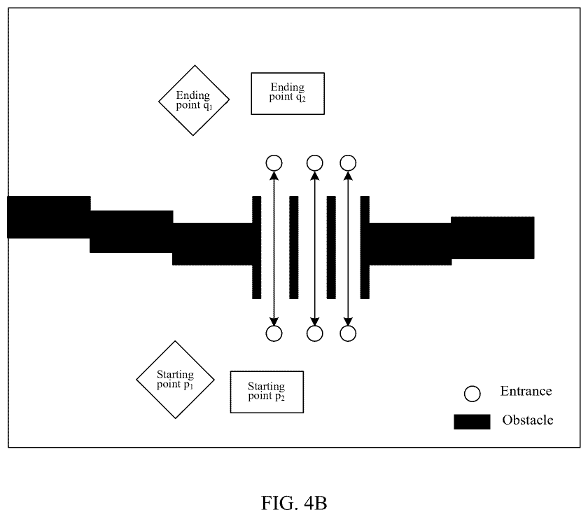

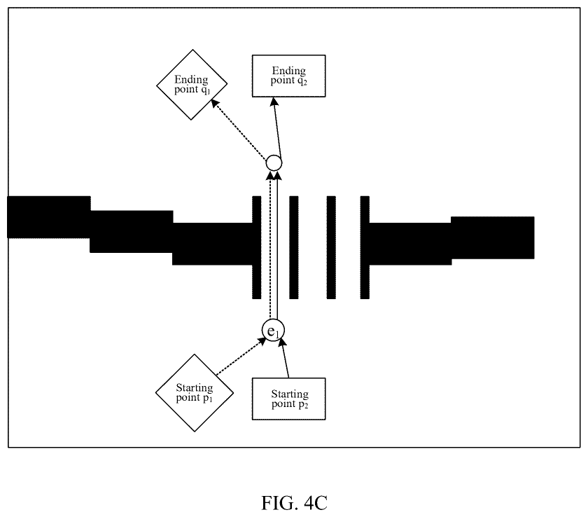

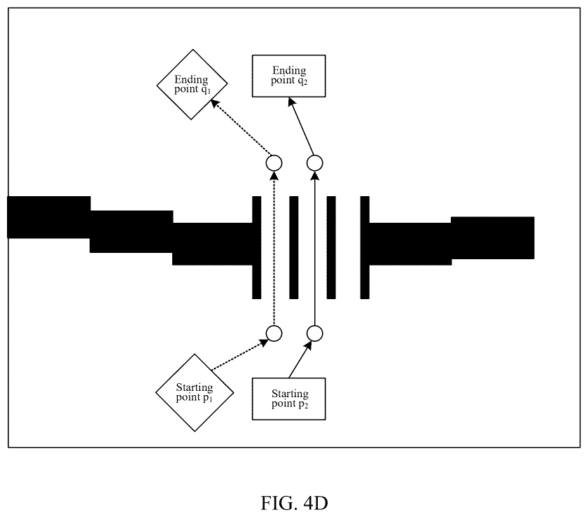

FIG. 4A is a schematic diagram of a mobile machine dispatching method according to the first embodiment of the present disclosure. As shown in FIG. 4A, the passed channel through which the dispatching path of the n-th mobile machine passes may be channel 401. The first direction through which the dispatching path of the n-th mobile machine passes channel 401 is the direction from entrance e₁ of channel 401 to exit f₁ of that. The starting point of the dispatching path of the n-th mobile machine is starting point p₁. The first distance between starting point p₁ and entrance e₁ may be represented as L₁. In the case that the movement speeds of the N mobile machines in the area outside the channel are consistent, and the movement speed of the n-th mobile machine and that of the 1-st device in the area outside the channel are both the first speed, the first time duration required for the n-th mobile machine to reach entrance e₁ from the starting point of the dispatching path is the ratio between the first distance and the first speed. As equation (1.1) that is for determining the increment of the first cost, the product of the first time duration and the movement speed of the 1-st device in the area outside the channel is determined as the increment of the first cost. In which, the increment of the first cost may be determined using an equation of:

$$\frac{{L}_{1}}{{v}_{a}} {v}_{a} = {L}_{1} \qquad ( 1.1 )$$

where, L₁ is the first distance, vₐ is the first speed, and

$$\frac{{L}_{1}}{{v}_{a}}$$

is the first time duration.

In equation (1.1), the increment

$$\frac{{L}_{1}}{{v}_{a}} {v}_{a}$$

of the first cost is numerically equivalent to the first distance L₁, and the sum between the first cost and the first distance is taken as the updated first cost.

In this embodiment, the increment in the first cost actually reflects the resource cost of the 1-st mobile machine waiting for the n-th mobile machine outside the passed channel to arrive at the entrance of the passed channel. By updating the first cost of the channel, the passage capacity of the passed channel can be more accurately evaluated. In the process of the path planning of the subsequent mobile machine, based on the passing costs of the M channels, the channels through which the subsequent mobile machine to pass can be more reasonably allocated to the subsequent mobile machine, thereby reducing conflicts and waiting times between mobile machines, which improves the overall efficiency and stability of mobile machine dispatching.

In some embodiments, if the direction through which the dispatching path of the n-th mobile machine passes through the passed channel is the first direction, the passing cost of the passed channel may further include the second cost of passing the passed channel in the second direction, and the “updating the passing cost of any one of the plurality of channels” in step 102 of FIG. 3A may further include: obtaining a first speed and a second speed of the n-th mobile machine, and obtaining a second distance between the entrance of the channel and the exit of the channel; and increasing the second cost based on the first speed, the second speed, the first distance, and the second distance, and taking the increased first cost as an updated second cost.

In which, the passed channel is a two-way channel, the second direction is the direction from the exit of the passed channel to the entrance of that, the first speed is the movement speed of the n-th mobile machine in the area outside the passed channel, and the second speed is the movement speed of the n-th mobile machine in the passed channel.

As shown in FIG. 4A, if channel 401 is a two-way channel, the passed channel through which the dispatching path of the n-th mobile machine passes may be channel 401. The second direction is the direction from exit f₁ of channel 401 to entrance e₁ of that. The first speed and the second speed of the n-th mobile machine are obtained. The first speed may be represented as vₐ, the second speed may be represented as v_{b}, and the first distance between starting point p₁ of the dispatching path of the n-th mobile machine and entrance e₁ may be represented as L₁, and the second distance between entrance e₁ and exit f₁ may be represented as L₂. Based on the first speed vₐ, the second speed vₐ, the first distance L₁, and the second distance L₂, it may determine the increment of the second cost, and take the sum between the second cost and the increment of the second cost as the updated second cost.

In some embodiments, the “increasing the second cost based on the first speed, the second speed, the first distance, and the second distance, and taking the increased first cost as an updated second cost” shown above may include: determining a ratio between the first speed and the second speed, and determining a product between the ratio and the second distance; and determining a sum of the second cost, the first distance, and the product as the increased second cost.

As the foregoing example, in the case that the movement speeds of the N mobile machines in the area outside the channel are the same, and that of the N mobile machines in the area outside the M channels are all the first speed, the first time duration required for the n-th mobile machine to reach the entrance of the passed channel from the starting point of the dispatching path is the ratio between the first distance and the first speed, and the second time duration required for the n-th mobile machine to reach the exit of the passed channel from the entrance of the passed channel is the ratio between the second distance and the second speed, that is, the third time duration required for the n-th mobile machine to reach the exit of the passed channel from the starting point of the dispatching path is the sum of the first time duration and the second time duration. Any mobile machine with the priority lower than the n-th mobile machine and passes through the passed channel in the second direction is determined as the 2-nd mobile machine. As equation (1.2) that is for determining the increment of the second cost, the product of the third time duration and the first speed of the second mobile machine in the area outside the passed channel is determined as the increment of the second cost. In which, the increment of the second cost may be determined using an equation of:

$$( \frac{{L}_{1}}{{v}_{a}} + \frac{{L}_{2}}{{v}_{b}} ) {v}_{a} = {L}_{1} + {L}_{2} \frac{{v}_{a}}{{v}_{b}} \qquad ( 1.2 )$$

where, L₁ is the first distance, L₂ is the second distance, vₐ is the first speed, vₚ is the second speed,

$$\frac{{L}_{1}}{{v}_{a}}$$

is the first time duration,

$$\frac{{L}_{2}}{{v}_{b}}$$

is the second time duration, and

$$( \frac{{L}_{1}}{{v}_{a}} + \frac{{L}_{2}}{{v}_{b}} )$$

is the third time duration.

In equation (1.2), the increment

$$( \frac{{L}_{1}}{{v}_{a}} + \frac{{L}_{2}}{{v}_{b}} ) {v}_{a}$$

of the second cost is numerically equivalent to

$${L}_{1} + {L}_{2} \frac{{v}_{a}}{{v}_{b}} , where \frac{{v}_{a}}{{v}_{b}}$$

is the ratio between the first speed and the second speed. It determines the product between the ratio

$$\frac{{v}_{a}}{{v}_{b}}$$

and the second distance L₂ as

$${L}_{2} \frac{{v}_{a}}{{v}_{b}} ,$$

determines the increment of the second cost as the sum of the first distance L₁ and the product

$${L}_{2} \frac{{v}_{a}}{{v}_{b}} ,$$

and determines the sum of the second cost and the increment of the second cost as the updated second cost.

In this embodiment, the increment of the second cost actually reflects the resource cost of the 2-nd device waiting outside the passed channel for the n-th mobile machine to pass through the passed channel. By updating the second cost of the passed channel, the two-way passage capacity of the passed channel can be more comprehensively evaluated, so that the passing cost of the passed channel not only takes into account the mobile machines passing in the same direction, but also takes into account the additional costs brought by the mobile machines passing in the reverse direction, thereby more accurately predicting and avoiding congestion or conflicts that could be caused by two-way passages during the path planning for the mobile machines.

103: obtaining the dispatching path of the (n+1)-th mobile machine by performing a path planning on the (n+1)-th mobile machine based on the updated passing cost of said one of the M channels and the passing costs of the rest M−1 channels.

As an example, based on the updated passing cost of the passed channel and the passing costs of the rest M−1 channels other than the passed channel, it may search the dispatching path of the (n+1)-th mobile machine on the raster map. In which, the dispatching path of the (n+1)-th mobile machine may pass through any of the M channels, or may not pass through any of the M channels.

In some embodiments, the path planning is implemented by searching for the dispatching path on the grid map. FIG. 3B is a flow chart of a mobile machine dispatching method according to the second embodiment of the present disclosure. As shown in FIG. 3B, step 103 in FIG. 3A may include steps 1031-1035.

1031: determining a starting grid where a starting point of the dispatching path of the (n+1)-th mobile machine is located in the grid map, and determining a grid cost of the starting grid.

As an example, it may determine the starting raster where the starting point of the dispatching path of the (n+1)-th mobile machine is located from the raster map, and determine a raster number and a raster cost of the starting raster, where the raster cost of the starting raster is the distance between the starting point of the dispatching path of the (n+1)-th mobile machine and the ending point of the dispatching path of the (n+1)-th mobile machine.

1032: constructing a node corresponding to the starting grid based on the grid cost of the starting grid, and storing the constructed node into a candidate node set.

As an example, in the candidate node set, the candidate nodes included in it may be managed and stored through the data structure of a min-heap binary tree, the raster number and the raster cost of the starting raster may be stored in the initial node, and the initial node storing the raster number and raster cost of the starting raster may be determined as the node corresponding to the starting raster so as to store in the candidate node set as a root node of the min-heap binary tree.

The following steps 1033-1035 are to be performed iteratively.

1033: determining a first grid with the smallest grid cost among the grids corresponding to the nodes in the candidate node set.

As an example, in the first iteration, it may determine the starting raster as the first raster; and in the iterations after the first iteration, it may search the raster with the smallest raster cost from the rasters corresponding to the nodes included in the candidate node set to take the raster with the smallest raster cost as the first raster.

1034: in response to the first grid being not an end grid where an ending point of the dispatching path of the (n+1)-th mobile machine is located, searching for at least a second grid in the grid map based on the updated passing cost of the passed channel and the passing costs of the M−1 channels other than the passed channel, and storing the searched node corresponding to the searched second grid into the candidate node set.

As an example, it may determine, from the grid map, the grids where the openings of the M channels are located. If the first grid is the grid where one of the openings of the first channel is located, and the direction from the first grid to the other opening of the first channel is the passable direction of the first channel, the first grid is the grid where the entrance of the first channel is located; otherwise, if the first grid is the grid where one of the openings of the first channel is located, and the direction from the first grid to the other opening of the first channel is not the passable direction of the first channel, the first grid is the grid where the exit of the first channel is located.

FIG. 3C is a flow chart of a mobile machine dispatching method according to the third embodiment of the present disclosure. As shown in FIG. 3C, in some embodiments, if the first grid is the grid where the entrance of the first channel is located, and the first channel is any one of the M channels, step 1034 shown in FIG. 3B may include steps 201A-204A.

201A: determining a third cost of entering the first channel with the entrance of the passed channel from the updated passing cost of the channel and the passing costs of the M−1 channels except the passed channel.

As an example, it may determine, from the updated passing cost of the passed channel and the passing costs of the M−1 channels other than the passed channel, the third cost of entering the first channel through the entrance of the passed channel that is included in the passing cost of the first channel.

202A: taking a grid where the exit of the first channel is located as the second grid, and determining a third distance between the exit of the channel and the ending point of the dispatching path.

As an example, it may determine the grid in the grids where the opening of the first channel is located other than the first grid as the grid where the exit of the channel is located, determine the grid where the exit of the first channel is located as the second grid, and determine the third distance between the exit of the first channel and the ending point of the dispatching path of the (n+1)-th mobile machine.

203A: determining a sum of the grid cost of the first grid, the third cost, and the third distance as the grid cost of the second grid.

FIG. 4A is a schematic diagram of a mobile machine dispatching method according to the first embodiment of the present disclosure. As shown in FIG. 4A, the first channel may be channel 401, the first grid may be the grid where entrance e₁ is located, and the second grid may be the grid where exit f₁ is located. It may determine the sum of the grid cost of the first grid, the third cost, and the third distance between exit f₁ and ending point q₁ of the dispatching path of the (n+1)-th mobile machine as the grid cost of the second grid.

204A: constructing a node corresponding to the second grid based on the grid cost of the second grid, and storing the node corresponding to the second grid into the candidate node set.

In which, the node corresponding to the second grid is a sub-node corresponding to the node corresponding to the first grid.

As an example, it may construct the node corresponding to the second grid based on the grid number of the second grid, the grid cost of the second grid, and the grid number of the first grid, and store the node corresponding to the second grid in the candidate node set as the sub-node of the node corresponding to the first grid.

In this embodiment, if the first grid is the grid where the entrance of the passed channel is located, the grid where the exit of the passed channel is located may be determined as the second grid. Compared with searching adjacent grids one by one, ineffective explorations inside the channel are avoided and computing resources are saved. The third cost of the first channel, the distance from the exit of the first channel to the ending point of the dispatching path, and the grid cost of the first grid are summed to determine the grid cost of the second grid, which can more comprehensively evaluate the feasibility of path, thereby ensuring the optimality of path planning. In addition, the nodes of the second grid are taken as the sub-nodes of the first grid node to store into the candidate node set, which not only achieves hierarchical storage and management of the candidate node set, but also facilitates the subsequent path backtracking.

FIG. 3D is a flow chart of a mobile machine dispatching method according to the fourth embodiment of the present disclosure. As shown in 3D, in some embodiments, if the first grid is not the grid where the opening is located, step 1034 shown in FIG. 3B may include steps 201B-204B.

201B: determining the second grid from grids adjacent to the first grid.

In some embodiments, step 201B shown in FIG. 3D may include steps of: determining third grids that are accessible and adjacent to the first grid, and taking the third grids as the second grid; and querying a parent node of the node corresponding to the first grid in the candidate node set, taking a grid corresponding to the parent node as a fourth grid, taking a grid in the third grids that is on a direction from the fourth grid to the first grid as the second grid.

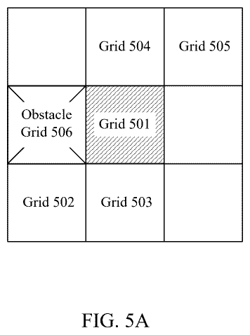

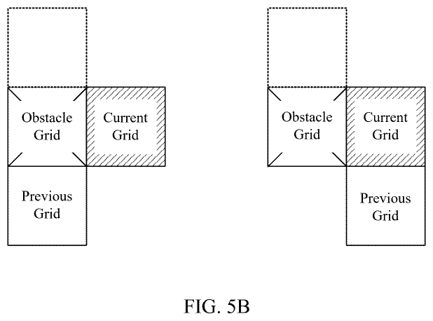

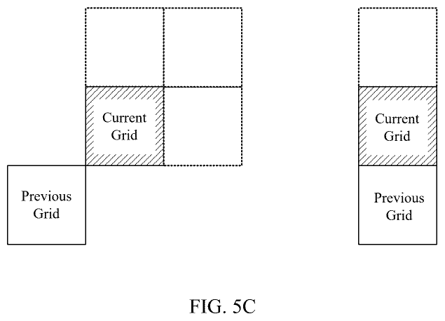

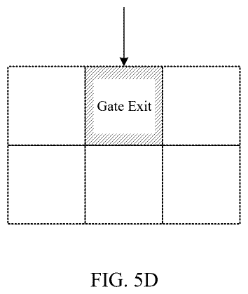

As an example, it may determine the third grids that are passable and adjacent to the first grid to determine as the second grid, where the passable grid refers to the grid that is not occupied by obstacles. FIG. 5A is a schematic diagram of a mobile machine dispatching method according to the fifth embodiment of the present disclosure. As shown in FIG. 5A, in some embodiments, the first grid may be grid 501. It may take the grids adjacent to grid 501 other than grid 506 as the third grids, and take the third grids as the second grid.

Alternatively, it may query the parent node of the nodes corresponding to the first grid from the candidate node set, determine the direction from the fourth grid to the first grid, and take the grid in the third grids that lies along the direction as the second grid. As shown in FIG. 5A, in some embodiments, the first grid may be grid 501, and if the fourth grid is grid 502, the grid in the third grids that is in the direction from the fourth grid to the first grid is grid 505, and grid 505 is taken as the second grid; otherwise, if the fourth grid is grid 503, the grid in the third grids that is in the direction from the fourth grid to the first grid is grid 504, and grid 504 is taken as the second grid.

In this embodiment, the rigor and completeness of a path search are ensured by directly determining the third grids that are passable and adjacent to the first grid as the second grid. On this basis, the second grid can be further filtered from the third grids by combining the direction from the fourth grid to the first grid so as to guide the path search through the direction information. In this manner, ineffective searches and path detours are reduced, thereby improving the efficiency and accuracy of path planning.

The following steps 202B-204B are to be performed for the second grid:

202B: determining a fourth distance between the second grid and the first grid, and determining a fifth distance between the second grid and the ending point of the dispatching path.

203B: determining a sum of the grid cost of the first grid, the fourth distance, and the fifth distance as the grid cost of the second grid.

204B: constructing the node corresponding to the second grid based on the grid cost of the second grid to store into the candidate node set.

In which, the node corresponding to the second grid is a sub-node corresponding to the node corresponding to the first grid.

As an example, the details of steps 202B-204B may refer to steps 202A-204A.

In this embodiment, if the first grid is not the grid where the opening is located, the grid cost of the second grid may be determined based on the distance with respect to the first grid and that with respect to the ending point that are combined with the grid cost of the first grid, so that the feasibility of the path can be more comprehensively evaluated, thereby ensuring the optimality of path planning. In addition, the node of the second grid is stored in the candidate node set as a sub-node of the first grid node, which not only achieves hierarchical storage and management of the candidate node set, but also facilitates the subsequent path backtracking.

In some embodiments, if the first grid is the grid where the exit of the first channel is located, and the first channel is any one of the M channels, step 1034 shown in FIG. 3B may include: determining the grid adjacent to the grid where the exit is located as the second grid; constructing the node corresponding to the second grid to store into the candidate node set.

In which, the node corresponding to the second grid is a sub-node corresponding to the node corresponding to the first grid.

As an example, it may determine the grid adjacent to the grid where the exit is located as the second grid. If the number of the second grid is larger than 1, for each second grid, the node corresponding to the second grid is constructed, and the node corresponding to each second grid is stored as a sub-node of the node corresponding to the first grid into the candidate node set, where “constructing the node corresponding to each second grid” refer to the above-mentioned steps 202A-204A.

In this embodiment, if the first grid is the grid where the exit is located, the grid adjacent to the exit may be determined as the second grid. By only considering the grid adjacent to the exit, it is possible to quickly focus on the path direction that is most likely to lead to the ending point, thereby improving the efficiency of path search. The grid cost of the second grid is determined by summing the sixth distance between each second grid and the first grid, the seventh distance between the second grid and the ending point, and the grid cost of the first grid, which can more comprehensively evaluate the feasibility of the path, thereby ensuring the optimality of path planning. In addition, by storing the node of the second grid as a sub-node of the first grid node into the candidate node set, which not only achieves hierarchical storage and management of the candidate node set, but also facilitates subsequent path backtracking.

1035: in response to the first grid being the end grid, obtaining the dispatching path of the (n+1)-th mobile machine by performing a path backtracking based on the candidate node set, and stopping the iteration.

In some embodiments, step 1035 shown in FIG. 3B may include: querying the node corresponding to the end raster based on the candidate node set, and determining the node corresponding to the end raster as the 1-st node in the node sequence; querying the parent node of the j-th node in the node sequence based on the candidate node set, and determining the parent node of the j-th node as the j+1-th node in the node sequence; and if the parent node of the J-th node in the node sequence cannot be queried out based on the candidate node set, connect the J grids respectively corresponding to the J nodes included in the node sequence in reverse order so as to obtain the dispatching path of the (n+1)-th mobile machine.

In which, j is a positive integer that increases sequentially.

As an example, it may query the node corresponding to the end grid from the candidate node set, and determine the node corresponding to the end grid as the 1-st node in the node sequence. It may further query the parent node of the 1-st node in the node sequence from the candidate node set, determine the parent node of the 1-st node as the 2-nd node in the node sequence, and so on, until the parent node of the J-th node in the node sequence cannot be queried out in the candidate node set and the iteration is stopped. The fact that the parent node of the J-th node cannot be queried out indicates that the J-th node is the root node of the min-heap binary tree used by the candidate node set to store and manage the candidate nodes, that is, the J-th node is the node used by the path starting point of the (n+1)-th device. The J grids corresponding to the J nodes included in the node sequence are connected in reverse order to obtain the dispatching path of the (n+1)-th device.

In this embodiment, by querying the parent node in the candidate node set in a level-by-level manner from the node corresponding to the end raster so as to construct a complete node sequence, the rasters corresponding to the nodes are finally connected in reverse order to generate the dispatching path of the (n+1)-th mobile machine. In this manner, the path information can be efficiently extracted from the candidate node set to ensure the coherence and accuracy of path. At the same time, the structural characteristics of the min-heap binary tree are used to quickly locate the starting point of the dispatching path, thereby providing an efficient and reliable path planning solution for mobile machine dispatching.

104: controlling the N mobile machines to move, according to the dispatching paths.

As an example, it may control the N mobile machines to move along their respective N dispatching paths in any order, where any two of the N mobile machines may move at the same time or one after another in a preset order.

Below, an exemplary application of this embodiment in an application scenario of dispatching a robot to pass through a gate will be described.

In a robot-gate dispatching system, a robot-gate dispatching algorithm is for determining the work order, path planning and task allocation of robots in a specific environment so as to efficiently assign corresponding tasks to each robot in scenarios where multiple robots need to coordinate their works, for example, in a system that requires multiple robots to perform tasks separately or in cooperation with each other (e.g., automated warehouse or airport baggage handling), the robots may need to work collaboratively. By efficiently assigning corresponding tasks to each robot, the conflicts between robots can be avoided to reduce unnecessary waiting time and avoid wasting time. In which, a gate as a traffic control facility is common in public transportation, airport, and other scenarios, which has main function of controlling the flow of people or equipment to ensure safety and order.

Regarding the related technologies, in scenarios where needs to dispatch robots to pass through a gate, due to the difficulty in ensuring a robot to reasonably avoid the other robots and pass through the gate smoothly during performing tasks, equipment congestion will tend to occur, while the related techniques have difficulty in quickly responding to the needs of different robots.

In view of the problems existing in the related technologies, in this embodiment, a mobile machine dispatching method is provided. By reasonably allocating the gate to each robot, the efficiency of passing through the gate can be maximized, while the dispatching path for each robot is planned.

In this embodiment, the mobile machine dispatching method has the following characteristics:
1) Path allocation and collaboration: the mobile machine dispatching method is provided to reasonably allocate a dispatching path to each robot while taking into account the passing efficiency of each gate in different directions.
2) Adaptability: each robot uses the same dispatching logic to adjust the path of the robot in real time by assigning different dispatching priorities to different robot, respectively.
3) Global approximate optimal: the optimal time for each robot to pass through the gate is considered when planning path for the robot, thereby achieving a global approximate optimal dispatching effect.
4) Path planning: a global dispatching path for passing through the corresponding gate is generated for each robot while assigning the gate to the robot.
5) Wide range of applications: the mobile machine dispatching method can be applied to dispatching scenarios where any number of robots pass through any number of gates, which has a wide range of applications.
6) Low computing performance requirements: the mobile machine dispatching method can achieve the calculations of path planning in a very short time when planning path for multiple robots, which does not require high computing performance of the system.

The mobile machine dispatching method will be described below from the aspects of data input, multi-machine dispatching, gate status information, gate selection, and path planning.

### 1. Data Input

In this embodiment, the input data for the mobile machine dispatching method may include: robot task information, a robot priority, gate information, and a grid map.

### 1) Task Information of Robot

For the i-th robot among the N robots (i.e., the above-mentioned N mobile machines), the task information of the i-th robot may include starting point coordinates

$${p}_{i} = {[ {x}_{i}^{p} , {y}_{i}^{p} ]}^{T}$$

and ending point coordinates

$${q}_{i} = {[ {x}_{i}^{q} , {y}_{i}^{q} ]}^{T} ,$$

where i∈{1, . . . , N}.

### 2) The Priority of Robot

The priority of the i-th robot among the N robots (i.e., the above-mentioned priority) may be represented as hᵢ, where hᵢ∈ [symbol] , and the priority of each robot is unique, that is, there are no two robots with the same priority.

### 3) Gate Information

For the j-th gate among the M gates (i.e., the above-mentioned M channels), the information of the j-th gate may include entrance coordinates

$${e}_{j} = {[ {x}_{j}^{e} , {y}_{j}^{e} ]}^{T}$$

and exit coordinates

$${f}_{j} = {[ {x}_{j}^{f} , {y}_{j}^{f} ]}^{T} ,$$

where j∈{1, . . . , M}.

### 4) Raster Map

A grid map is for representing safe and unsafe information on the map, and the starting point and the ending point of all the robots must be located inside the grid map.

FIG. 4B is a schematic diagram of a mobile machine dispatching method according to the second embodiment of the present disclosure. As shown in FIG. 4B, the black area represents the area where obstacles are located, that is, the unsafe area; the circle represents the entrance or exit of the gate; and the quadrilateral represents the starting point or the ending point of the robot. In which, the task information of robot 1 includes starting point p₁ and ending point q₁, and the task information of robot 2 includes starting point p₂ and ending point q₂.

FIG. 4C is a schematic diagram of a mobile machine dispatching method according to the third embodiment of the present disclosure. As shown in 4C, in the case that there is no multi-gate dispatching applied on robot 1 and robot 2, when robot 1 and robot 2 try to pass through the gate, both of them will choose to reach the ending point through gate entrance e₁ closest to their starting points. The closer robot 2 will pass through the gate first, and then the farther robot 1 needs to wait for the previous robot 2 to completely pass the gate before passing through the gate. Therefore, it takes a long time for the two robots to pass through the gate as a whole, and the efficiency is low.

Therefore, in this embodiment, the problem to be solved by the mobile machine dispatching method is how to allocate M gates to N robots while considering the task priority, so that the overall efficiency of all the robots to pass through the gates is higher. FIG. 4D is a schematic diagram of a mobile machine dispatching method according to the fourth embodiment of the present disclosure. As shown in FIG. 4D, if robot 1 and robot 2 select different gates, respectively, they can pass through the gate at the same time, and the overall efficiency of the robots passing through the gate is improved.

### 2. Multi-Machine Dispatching

In this embodiment, in order to achieve the foregoing effects, the robot-gate dispatching algorithm needs to comply with the following principles:
Principle 1: the robot with higher priority is assigned faster gate and path.
Principle 2: when there are multiple robots to pass through a gate, it is faster to pass in the same direction than in the opposite direction.
Principle 3: the robot can pass through the gate or just bypass it.

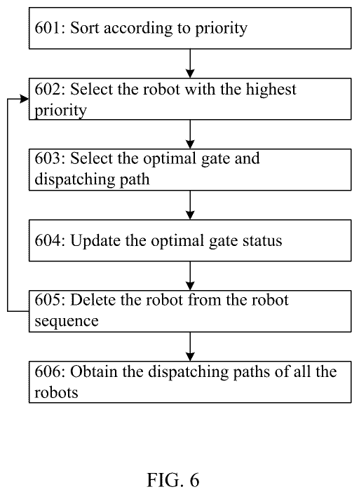

FIG. 6 is a flow chart of a mobile machine dispatching method according to the fifth embodiment of the present disclosure. As shown in FIG. 6, in this embodiment, according to principle 1 of the robot-gate dispatching algorithm, the main algorithm framework of the robot-gate dispatching algorithm is constructed. The robot-gate dispatching algorithm may include the following steps.

601: sorting according to priority.

Based on priority hᵢ of the robot from high to low, the N robots are sorted to obtain a robot sequence, then proceed to 602.

602: selecting the robot with the highest priority.

The robots are sorted according to the priority to select the robot with the highest priority from the robot sequence for path planning, then proceed to step 603.

603: selecting the optimal gate and dispatching path.

Whether the robot passes through any gate and/or which gate it passes are determine according to the status (i.e., the above-mentioned passing cost) of the M gates, and the dispatching path of the robot is determined, then proceed to step 604.

604: updating the optimal gate status, then proceed to step 605.

605: deleting the robot from the robot sequence.

After determining the dispatching path of the robot, the robot is deleted from the robot sequence, then proceed to step 602. If there is no robot in the robot sequence that has not performed path planning yet, proceed to step 606.

606: obtaining the dispatching paths of all the robots.

The above-mentioned steps may be repeated until the gate and the dispatching path selected for all the robots are determined.

In this manner, the robot with higher priority will first occupy the faster gate, then the status of the gate is updated to allow the robot with lower priority to choose other gates.

### 3. Gate Status Information

According to principle 1 and principle 2 of the robot-gate dispatching algorithm, the status of the j-th gate is represented by the passing costs cⱼ′ and cⱼ″. The passing cost refers to the maximum time the robot needs to wait multiplied by the speed of the robot if it chooses to pass the gate. In which, a two-way gate (i.e., the above-mentioned two-way channel) has two passing costs cⱼ′ and cⱼ″ that represent passage from both ends. A one-way gate (i.e., the above-mentioned one-way channel) has only one valid passing cost

$${c}_{j}^{′} or {c}_{j}^{″} .$$

After each path planning and gate assignment on a robot, the passing cost of the gate needs to be updated. The update of the passing cost of the gate is explained below.

As shown in FIG. 4A, robot 1 chooses to pass through gate 1 (i.e., channel 401). The shortest path for robot 1 to pass through gate 1 includes the path from starting point p₁ to gate entrance e₁, with a path length of L₁, and the path from gate entrance e₁ to gate exit f₁, with a path length of L₂.

In the case that gate 1 is a two-way gate, if there is another robot to pass through gate 1, the robot will have to wait at most for robot 1 to arrive e₁, and then take turn to pass through the gate with robot 1; otherwise, if there is another robot to pass through gate 1 from f₁, the robot will have to wait at most for robot 1 to arrive f₁ through gate 1 before entering the gate.

Therefore, cost

$${c}_{1}^{′}$$

(i.e., the above-mentioned first cost) of gate 1 in the same direction is increased by

$$\frac{{L}_{1}}{{v}_{a}} {v}_{a} = {l}_{1} ,$$

and cost

$${c}_{1}^{″}$$

(i.e., the above-mentioned second cost) of gate 1 in the opposite direction is increased by

$$( \frac{{L}_{1}}{{v}_{a}} + \frac{{L}_{2}}{{v}_{b}} ) {v}_{a} = {L}_{1} + {L}_{2} \frac{{v}_{a}}{{v}_{b}} ,$$

where vₐ is the speed of the robot, and v_{b} is the speed of the robot when passing through the gate.

Whenever there is a robot chooses a gate, the passing cost of the gate will be increased, while the passing cost of passing in the opposite direction will be increased more significantly. Therefore, when there are other robots to make choices, they will consider passing other better gates.

### 4. Gate Selection and Path Planning

In this embodiment, the gate selection and the path planning are integrated into one algorithm to perform path planning of the current robot on the grid map, and the dispatching path of the current robot is directly output based on the result of path planning.

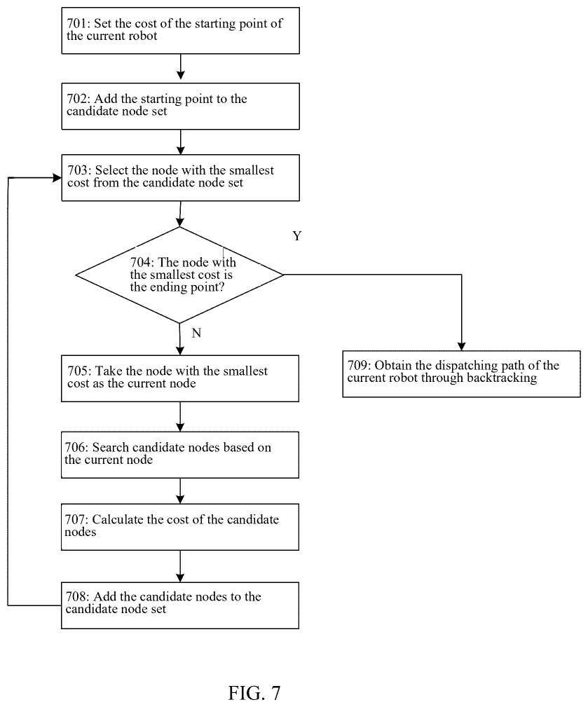

In this embodiment, the mobile machine dispatching method adopts a search algorithm on the grid map, takes a grid as the unit, and performs path search from the starting point until the ending point is searched. In order to search for the optimal path-gate solution, whenever a grid is searched out, the optimal next grid is determined, and whether the next grid needs to pass through the gate is determined, then which gate has the lowest cost is determined if it needs to pass through the gate. FIG. 7 is a flow chart of a mobile machine dispatching method according to the sixth embodiment of the present disclosure. As shown in FIG. 7, the gate selection and path planning may include the following steps.

701: setting the cost of the starting point of the current robot.

The cost of the starting point of the current robot (i.e., the grid cost of the grid where the above-mentioned starting point of the dispatching path is located) is determined, then proceed to step 702.

702: adding the starting point to the candidate node set, then proceed to step 703.

703: selecting the node with the smallest cost from the candidate node set, then proceed to step 704.

704: determining whether the node with the smallest cost is the ending point.

If the node with the smallest cost is not the ending point, then proceed to step 705. Otherwise, if the node with the lowest cost is the ending point, then proceed to step 709.

705: taking the node with the smallest cost as the current node, then proceed to step 706.

706: searching candidate nodes based on the current node, then proceed to step 707.

707: calculating the cost of the candidate nodes, then proceed to step 708.

708: adding the candidate nodes to the candidate node set, then proceed to step 703.

709: obtaining the dispatching path of the current robot through backtracking.

The search algorithm used by the mobile machine dispatching method on the grid map will be specifically described below from four aspects: candidate node collection, searching candidate node, determining the cost of candidate node, and backtracking result.

### 1) Candidate Node Set

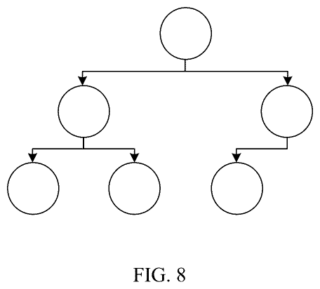

In this embodiment, the candidate node set may be implemented using the data structure of min-heap. Min-heap is a special binary tree structure. FIG. 8 is a schematic diagram of a mobile machine dispatching method according to the nineth embodiment of the present disclosure. As shown in FIG. 8, the candidate node set may be represented as a min-heap with 6 nodes, where each node store corresponding grid information.

In this embodiment, the characteristics of the min-heap may include: the grid information stored in each node includes grid coordinates, cost, the gate number to which a grid belongs, and the number of the previous grid; the cost of each node is less than that of all its sub-nodes, and the root node is the node with the smallest cost; and only the root node and the last node can have no sibling nodes, while the other nodes must have sibling nodes.

The above-mentioned characteristics of the min-heap ensure that during each iteration, the node with the lowest cost in the candidate node set can be quickly obtained by directly accessing the root node.

### 2) Search for Candidate Nodes

The minimum cost node in the candidate node set may be used as the current node to search candidate nodes based on the current node, and the grid number of the current node may be determined as the previous grid number of the candidate nodes. During searching, there are three situations to process: first, searching the area outside the gate; second, searching until the gate entrance is reached; and third, searching until the gate exit is reached.

As shown in TAB. 1, in order to quickly determine whether the grid is related to the gate, the gate information may be stored in a hash table structure:

TABLE 1
Gate information

| Grid | Corresponding | Corresponding |
|---|---|---|
| number | exit number | gate number |
| 1 | 4 | 1 |
| 2 | 3 | 2 |
| 3 | 0 | 2 |
| 4 | 1 | 1 |

From the grid number, it may directly query whether the grid belongs to the entrance of the gate, and may directly obtain the number of its corresponding exit. The number 0 represents a one-way gate, while the direction is inaccessible.

In the first situation, it searches in the area outside the gate, that is, the current node is irrelevant to the gate, the current node may be the starting point, and there may or may not be obstacles around the current node.

FIG. 5A is a schematic diagram of a mobile machine dispatching method according to the fifth embodiment of the present disclosure. As shown in FIG. 5A, in the case that the current node is the starting point, the grid where the starting point is located may be grid 501, and all safe grids around grid 501 where the starting point is located are directly taken as the candidate grids, that is, the seven grids around grid 501 except obstacle grid 506 are taken as the candidate grids.

FIG. 5B is a schematic diagram of a mobile machine dispatching method according to the sixth embodiment of the present disclosure. As shown in FIG. 5B, in the case that there are obstacles around the current node, by combining the number of the previous grid included in the current node, the safe grid around the obstacle may be determined as the candidate grids. The current grid and the previous grid corresponding to the current node, and the obstacle grid are determined respectively, and the dotted grids are determined as the candidate grids.

FIG. 5C is a schematic diagram of a mobile machine dispatching method according to the seventh embodiment of the present disclosure. As shown in FIG. 5C, in the case that there is no obstacle around the current node, by combining the number of the previous grid included in the current node, the surrounding safe grids in the same direction may be determined as the candidate grids. The current grid and the previous grid corresponding to the current node are determined respectively, and the surrounding dotted grids in the same direction are determined as the candidate grids.

In the second situation, the current node is the entrance of the gate, and the hash table is queried to determine whether the gate can be passed in the current direction (the direction entering the gate from the current node). If yes, it may determine the exit of the gate as the candidate grid, and record the corresponding gate number of the grid.

FIG. 5D is a schematic diagram of a mobile machine dispatching method according to the eighth embodiment of the present disclosure. As shown in FIG. 5D, in the third situation, the current node is the exit of the gate, and the surrounding grids outside the gate are added to the candidate grids. The surrounding dotted grids outside the gate in the same direction as the gate are determined as the candidate grids.

### 3) Determine the Cost of the Candidate Nodes

During determining the cost of the candidate nodes corresponding to each candidate grid, there are three situations to be considered: first, searching the area outside the gate; second, searching until the gate entrance is reached; and third, searching until the gate exit is reached.

In the first situation, the current node is irrelevant to the gate, and the cost of each candidate node is the cost of the previous node plus the distance from the current node to the previous node, and further plus the distance between the candidate node and the ending point.

In the second situation, the current node happens to be the gate entrance, then the cost of the candidate node is the cost of the previous node plus the cost of the gate, and further plus the distance between the candidate node and the ending point.

In the third situation, which can refer to the first case.

In this embodiment, in order to speed up the path search, when determining the cost of a node, an additional cost is added. This additional cost is defined as the distance from the grid of the candidate node to the ending point of the task, so that whenever selecting the minimum cost node, the ending point of the task can be gradually approached, and then all the candidate nodes are added to the candidate node set.

### 4) Backtrack Result

In the case that the minimum cost node in the candidate node set is the ending point of the task, the path search is ended, the number of the previous node is obtained from the current node information to determine the previous node, and then repeat the backtracking to obtain the optimal comprehensive result of path-gate. Since the information of the gate is recorded in the node, whether the entire result includes passing through the gate and the gates having been passed can be directly obtained during backtracking.

In this embodiment, the mobile machine dispatching method mainly includes the following beneficial effects:
1) The overall framework integrates path search and gate dispatching. By searching on the grid map, the final dispatching path and passed gates can be obtained directly, which avoids the need to design complex dispatching logic.
2) The dispatching problems of multiple robots and multiple gates in the same scenario are considered, which has a relatively more application scenarios. In addition, the gates are abstracted to a certain extent, and can theoretically be applied to the scenario of any type of gate.
3) An optimal cost dispatching framework is designed to ensure the optimization of dispatching paths and gate allocations while adhering to task priorities, thereby achieving optimal overall efficiency.
4) A variety of high-efficiency data structures such as min-heaps and hash tables are used, which improves the computing efficiency of the entire gate dispatching system and requires lower computing resources.

An exemplary structure in which the mobile machine dispatching apparatus 555 is implemented as a software module is described below. In some embodiments, as shown in FIG. 2, the software modules stored in the mobile machine dispatching apparatus 555 of the storage 550 may include:
the mobile machine management module 5551 configured to search a dispatching path of each of N mobile machines in an order of priorities of the N mobile machines from high to low;
the cost management module 5552 configured to update a passing cost of at least one of M channels in response to the channel being passed through by the searched dispatching path of the n-th mobile machine;
the path searching module 5553 configured to obtain the dispatching path of the (n+1)-th mobile machine by performing a path planning on the (n+1)-th mobile machine based on the updated passing cost of the passed channel and the passing costs of the M−1 channels other than the passed channel; and
the mobile machine management execution module 5554 configured to control, according to the dispatching path of each of the N mobile machines, the N mobile machines to move.

In some embodiments, if a direction through which the dispatching path of the n-th mobile machine passes the channel is a first direction, the passing cost of the channel includes a first cost of passing through the channel in the first direction, and the first direction is from an entrance of the channel to an exit of the channel; and the cost management module 5552 may be further configured to: determine a first distance between a starting point of the dispatching path of the n-th mobile machine and the entrance of the channel; and increase the first cost based on the first distance, and taking the increased first cost as an updated first cost.

In some embodiments, the passing cost of the channel further includes a second cost of passing through the channel in a second direction, and the second direction is from the exit of the channel to the entrance of the channel; and the cost management module 5552 may be further configured to: obtaining a first speed and a second speed of the n-the mobile machine, and obtaining a second distance between the entrance of the channel and the exit of the channel, where the first speed is a movement speed of the n-th mobile machine outside the channel, and the second speed is a movement speed of the n-th mobile machine inside the channel; and increasing the second cost based on the first speed, the second speed, the first distance, and the second distance, and taking the increased first cost as an updated second cost.

In some embodiments, the cost management module 5552 may be further configured to: determining a ratio between the first speed and the second speed, and determining a product between the ratio and the second distance; determining a sum of the second cost, the first distance, and the product as the increased second cost.

In some embodiments, the path planning is a search for the dispatching path on a grid map, and the path searching module 5553 is further configured to: determining a starting grid where a starting point of the dispatching path of the (n+1)-th mobile machine is located in the grid map, and determining a grid cost of the starting grid; constructing a node corresponding to the starting grid based on the grid cost of the starting grid, and storing the constructed node into a candidate node set; and performing an iteration of: determining a first grid with the smallest grid cost among the grids corresponding to the nodes in the candidate node set; in response to the first grid being not an end grid where an ending point of the dispatching path of the (n+1)-th mobile machine is located, searching for at least a second grid in the grid map based on the updated passing cost of the passed channel and the passing costs of the M−1 channels except the passed channel, and storing the searched node corresponding to the searched second grid into the candidate node set; in response to the first grid being the end grid, obtaining the dispatching path of the (n+1)-th mobile machine by performing a path backtracking based on the candidate node set, and stopping the iteration.

In some embodiments, if the first grid is a grid where the entrance of the channel of the first channel is located, and the first channel is any one of the M channels, the path planning is a search for the dispatching paths on a grid map, and the path searching module 5553 is further configured to: determining a third cost of entering the first channel with the entrance of the channel from the updated passing cost of the channel and the passing costs of the channels not being passed through by the searched dispatching path of the n-th mobile machine; taking a grid where the exit of the first channel is located as the second grid, and determining a third distance between the exit of the channel and the ending point of the dispatching path; determining a sum of the grid cost of the first grid, the third cost, and the third distance as the grid cost of the second grid; constructing the node corresponding to the second grid based on the grid cost of the second grid to store into the candidate node set; where the node corresponding to the second grid is a sub-node corresponding to the node corresponding to the first grid.

In some embodiments, if the first grid is not a grid where the entrance of the channel of the first channel is located, the path searching module 5553 is further configured to: determining the second grid from grids adjacent to the first grid, and performing, on the second grid, a processing of: determining a fourth distance between the second grid and the first grid, and determining a fifth distance between the second grid and the ending point of the dispatching path; determining a sum of the grid cost of the first grid, the fourth distance, and the fifth distance as the grid cost of the second grid; constructing the node corresponding to the second grid based on the grid cost of the second grid to store into the candidate node set; where the node corresponding to the second grid is a sub-node corresponding to the node corresponding to the first grid.

In some embodiments, the path searching module 5553 is further configured to: determining third grids that are accessible and adjacent to the first grid, and taking the third grids as the second grid; querying a parent node of the node corresponding to the first grid in the candidate node set, taking a grid corresponding to the parent node as a fourth grid, taking a grid in the third grids that is on a direction from the fourth grid to the first grid as the second grid.

In the embodiments of the present disclosure, a computer program product is provided. The computer program product includes computer program(s) or computer-executing instructions stored in the computer-readable storage medium. The processor of the electronic device reads the computer-executing instructions from the computer-readable storage medium, where the processor executes the computer-executing instructions so that the electronic device executes the above-mentioned device mode.

The embodiments of the present disclosure provide a computer-readable storage medium which stores computer-executable instructions or computer program(s). When the computer-executable instructions or the computer program(s) are executed by a processor, the processor is enabled to executable.

In some embodiments, the computer-readable storage medium may be a storage such as RAM, ROM, flash memory, magnetic surface memory, optical disk, or CD-ROM, and may also be various equipment including one of the forgoing storages or any combination of them.

In some embodiments, the computer-executable instructions may be implemented in the form of a program, software, software module, script or codes in any form of programming language (including compiled or interpreted languages, or declarative or procedural languages), and may be deployed in any form, including being deployed as a standalone program, a module, a component, a subroutine, or other unit suitable for use in a computing environment.

As an example, the computer-executable instructions may, but do not necessarily correspond to a file in the file system, and may be stored in a part of the file storing other programs or data, for example, in one or more scripts of a Hyper Text Markup Language (HTML) document, or stored in a single file dedicated to the program in question, or a plurality of collaborative files (e.g., files that store one or more modules, subroutines, or code parts).

As an example, the computer-executable instructions may be deployed to execute on one electronic device, or on a plurality of electronic devices located at one location, or a plurality of electronic devices distributed across multiple locations and interconnected over a communication network.

The foregoing are only the embodiments of the present disclosure and are not intended to limit the scope of the protection of the present disclosure. Any modification, equivalent substitution, improvement, and the like made within the spirit and scope of the present disclosure are included within the scope of the protection of the present disclosure.

What is claimed is:

1. A method for dispatching a plurality of mobile machines, comprising:
searching for dispatching paths of the mobile machines in descending order of priorities of the mobile machines;
updating a passing cost of one of a plurality of channels in response to finding the dispatching path of the n-th mobile machine passing through said one of the plurality of channels;
obtaining the dispatching path of the (n+1)-th mobile machine by performing a path planning on the (n+1)-th mobile machine based on the updated passing cost of said one of the plurality of channels and the passing costs of the rest channels; and
controlling the mobile machines to move, according to the dispatching paths.

2. The method of claim 1, wherein a direction that the dispatching path of the n-th mobile machine passes through the channel is a first direction, the passing cost of the channel includes a first cost of passing through the channel in the first direction, and the first direction is from an entrance of the channel to an exit of the channel; and updating the passing cost of one of the plurality of channels comprises:
determining a first distance between a starting point of the dispatching path of the n-th mobile machine and the entrance of the channel; and
increasing the first cost based on the first distance, and taking the increased first cost as an updated first cost.

3. The method of claim 2, wherein the passing cost of the channel further includes a second cost of passing through the channel in a second direction, and the second direction is from the exit of the channel to the entrance of the channel; and the method further comprises:
obtaining a first speed and a second speed of the n-th mobile machine, and obtaining a second distance between the entrance of the channel and the exit of the channel, wherein the first speed is a movement speed of the n-th mobile machine outside the channel, and the second speed is a movement speed of the n-th mobile machine inside the channel; and
increasing the second cost based on the first speed, the second speed, the first distance, and the second distance, and taking the increased first cost as an updated second cost.

4. The method of claim 3, wherein increasing the second cost based on the first speed, the second speed, the first distance, and the second distance comprises:
determining a ratio between the first speed and the second speed, and determining a product between the ratio and the second distance; and
determining a sum of the second cost, the first distance, and the product as the increased second cost.

5. The method of claim 1, wherein the path planning is a search for the dispatching path on a grid map; and obtaining the dispatching path of the (n+1)-th mobile machine by performing a path planning on the (n+1)-th mobile machine based on the updated passing cost of said one of the plurality of channels and the passing costs of the rest channels comprises:
determining a starting grid where a starting point of the dispatching path of the (n+1)-th mobile machine is located in the grid map, and determining a grid cost of the starting grid;
constructing a node corresponding to the starting grid based on the grid cost of the starting grid, and storing the constructed node into a candidate node set; and
performing an iteration of:
determining a first grid with the smallest grid cost among the grids corresponding to the nodes in the candidate node set;
in response to the first grid being not an end grid where an ending point of the dispatching path of the (n+1)-th mobile machine is located, searching for at least a second grid in the grid map based on the updated passing cost of the channel being passed through and the passing costs of the channels not being passed through by the searched dispatching path of the n-th mobile machine, and storing the searched node corresponding to the searched second grid into the candidate node set; and
in response to the first grid being the end grid, obtaining the dispatching path of the (n+1)-th mobile machine by performing a path backtracking based on the candidate node set, and stopping the iteration.

6. The method of claim 5, wherein if the first grid is a grid where an entrance or exit of the channel of the first channel is located, and the first channel is the channel being passed through by the searched dispatching path of the n-th mobile machine, searching for the second grid in the grid map based on the updated passing cost of the channel being passed through and the passing costs of the channels not being passed through by the searched dispatching path of the n-th mobile machine, and storing the searched node corresponding to the searched second grid into the candidate node set comprises:
determining a third cost of entering the first channel with the entrance of the channel from the updated passing cost of the channel and the passing costs of the channels not being passed through by the searched dispatching path of the n-th mobile machine;
taking a grid where the exit of the first channel is located as the second grid, and determining a third distance between the exit of the channel and the ending point of the dispatching path;
determining a sum of the grid cost of the first grid, the third cost, and the third distance as the grid cost of the second grid; and
constructing a node corresponding to the second grid based on the grid cost of the second grid, and storing the node corresponding to the second grid into the candidate node set, wherein the node corresponding to the second grid is a sub-node corresponding to the node corresponding to the first grid.

7. The method of claim 5, wherein if the first grid is not a grid where an entrance or exit of the channel of the first channel is located, searching for the second grid in the grid map based on the updated passing cost of the channel being passed through and the passing costs of the channels not being passed through by the searched dispatching path of the n-th mobile machine, and storing the searched node corresponding to the searched second grid into the candidate node set comprises:
determining the second grid from grids adjacent to the first grid, and performing, on the second grid, a processing of:
determining a fourth distance between the second grid and the first grid, and determining a fifth distance between the second grid and the ending point of the dispatching path;
determining a sum of the grid cost of the first grid, the fourth distance, and the fifth distance as the grid cost of the second grid; and
constructing the node corresponding to the second grid based on the grid cost of the second grid to store into the candidate node set, wherein the node corresponding to the second grid is a sub-node corresponding to the node corresponding to the first grid.

8. The method of claim 7, wherein determining the second grid from grids adjacent to the first grid comprises:
determining third grids that are accessible and adjacent to the first grid, and taking the third grids as the second grid; and
querying a parent node of the node corresponding to the first grid in the candidate node set, taking a grid corresponding to the parent node as a fourth grid, taking a grid in the third grids that is on a direction from the fourth grid to the first grid as the second grid.

9. An electronic device, comprising:
a processor;
a memory coupled to the processor; and
one or more computer programs stored in the memory and executable on the processor;
wherein, the one or more computer programs comprise:
instructions for searching for dispatching paths of a plurality of mobile machines in descending order of priorities of the mobile machines;
instructions for updating a passing cost of one of a plurality of channels in response to finding the dispatching path of the n-th mobile machine passing through said one of the plurality of channels;
instructions for obtaining the dispatching path of the (n+1)-th mobile machine by performing a path planning on the (n+1)-th mobile machine based on the updated passing cost of said one of the plurality of channels and the passing costs of the rest channels; and
instructions for controlling the mobile machines to move, according to the dispatching paths.

10. The electronic device of claim 9, wherein a direction that the dispatching path of the n-th mobile machine passes through the channel is a first direction, the passing cost of the channel includes a first cost of passing through the channel in the first direction, and the first direction is from an entrance of the channel to an exit of the channel; and instructions for updating the passing cost of one of the plurality of channels comprise:
instructions for determining a first distance between a starting point of the dispatching path of the n-th mobile machine and the entrance of the channel; and
instructions for increasing the first cost based on the first distance, and taking the increased first cost as an updated first cost.

11. The electronic device of claim 10, wherein the passing cost of the channel further includes a second cost of passing through the channel in a second direction, and the second direction is from the exit of the channel to the entrance of the channel; and instructions for the method further comprise:
instructions for obtaining a first speed and a second speed of the n-th mobile machine, and obtaining a second distance between the entrance of the channel and the exit of the channel, wherein the first speed is a movement speed of the n-th mobile machine outside the channel, and the second speed is a movement speed of the n-th mobile machine inside the channel; and
instructions for increasing the second cost based on the first speed, the second speed, the first distance, and the second distance, and taking the increased first cost as an updated second cost.

12. The electronic device of claim 11, wherein instructions for increasing the second cost based on the first speed, the second speed, the first distance, and the second distance comprise:
instructions for determining a ratio between the first speed and the second speed, and determining a product between the ratio and the second distance; and
instructions for determining a sum of the second cost, the first distance, and the product as the increased second cost.

13. The electronic device of claim 9, wherein the path planning is a search for the dispatching path on a grid map; and instructions for obtaining the dispatching path of the (n+1)-th mobile machine by performing a path planning on the (n+1)-th mobile machine based on the updated passing cost of said one of the plurality of channels and the passing costs of the rest channels comprise:
instructions for determining a starting grid where a starting point of the dispatching path of the (n+1)-th mobile machine is located in the grid map, and determining a grid cost of the starting grid;
instructions for constructing a node corresponding to the starting grid based on the grid cost of the starting grid, and storing the constructed node into a candidate node set; and
instructions for performing an iteration of:
determining a first grid with the smallest grid cost among the grids corresponding to the nodes in the candidate node set;
in response to the first grid being not an end grid where an ending point of the dispatching path of the (n+1)-th mobile machine is located, searching for at least a second grid in the grid map based on the updated passing cost of the channel being passed through and the passing costs of the channels not being passed through by the searched dispatching path of the n-th mobile machine, and storing the searched node corresponding to the searched second grid into the candidate node set; and
in response to the first grid being the end grid, obtaining the dispatching path of the (n+1)-th mobile machine by performing a path backtracking based on the candidate node set, and stopping the iteration.

14. The electronic device of claim 13, wherein if the first grid is a grid where an entrance or exit of the channel of the first channel is located, and the first channel is the channel being passed through by the searched dispatching path of the n-th mobile machine, instructions for searching for the second grid in the grid map based on the updated passing cost of the channel being passed through and the passing costs of the channels not being passed through by the searched dispatching path of the n-th mobile machine, and storing the searched node corresponding to the searched second grid into the candidate node set comprise:
instructions for determining a third cost of entering the first channel with the entrance of the channel from the updated passing cost of the channel and the passing costs of the channels not being passed through by the searched dispatching path of the n-th mobile machine;
instructions for taking a grid where the exit of the first channel is located as the second grid, and determining a third distance between the exit of the channel and the ending point of the dispatching path;
instructions for determining a sum of the grid cost of the first grid, the third cost, and the third distance as the grid cost of the second grid; and
instructions for constructing a node corresponding to the second grid based on the grid cost of the second grid, and storing the node corresponding to the second grid into the candidate node set, wherein the node corresponding to the second grid is a sub-node corresponding to the node corresponding to the first grid.

15. The electronic device of claim 13, wherein if the first grid is not a grid where an entrance or exit of the channel of the first channel is located, instructions for searching for the second grid in the grid map based on the updated passing cost of the channel being passed through and the passing costs of the channels not being passed through by the searched dispatching path of the n-th mobile machine, and storing the searched node corresponding to the searched second grid into the candidate node set comprise:
instructions for determining the second grid from grids adjacent to the first grid, and performing, on the second grid, a processing of:
instructions for determining a fourth distance between the second grid and the first grid, and determining a fifth distance between the second grid and the ending point of the dispatching path;
instructions for determining a sum of the grid cost of the first grid, the fourth distance, and the fifth distance as the grid cost of the second grid; and
instructions for constructing the node corresponding to the second grid based on the grid cost of the second grid to store into the candidate node set, wherein the node corresponding to the second grid is a sub-node corresponding to the node corresponding to the first grid.

16. The electronic device of claim 15, wherein instructions for determining the second grid from grids adjacent to the first grid comprise:
instructions for determining third grids that are accessible and adjacent to the first grid, and taking the third grids as the second grid; and
instructions for querying a parent node of the node corresponding to the first grid in the candidate node set, taking a grid corresponding to the parent node as a fourth grid, taking a grid in the third grids that is on a direction from the fourth grid to the first grid as the second grid.

17. A non-transitory computer-readable storage medium for storing one or more computer programs, wherein the one or more computer programs comprise:
instructions for searching for dispatching paths of a plurality of mobile machines in descending order of priorities of the mobile machines;
instructions for updating a passing cost of one of a plurality of channels in response to finding the dispatching path of the n-th mobile machine passing through said one of the plurality of channels;
instructions for obtaining the dispatching path of the (n+1)-th mobile machine by performing a path planning on the (n+1)-th mobile machine based on the updated passing cost of said one of the plurality of channels and the passing costs of the rest channels; and
instructions for controlling the mobile machines to move, according to the dispatching paths.

18. The storage medium of claim 17, wherein a direction that the dispatching path of the n-th mobile machine passes through the channel is a first direction, the passing cost of the channel includes a first cost of passing through the channel in the first direction, and the first direction is from an entrance of the channel to an exit of the channel; and instructions for updating the passing cost of one of the plurality of channels comprise:
instructions for determining a first distance between a starting point of the dispatching path of the n-th mobile machine and the entrance of the channel; and
instructions for increasing the first cost based on the first distance, and taking the increased first cost as an updated first cost.

19. The storage medium of claim 18, wherein the passing cost of the channel further includes a second cost of passing through the channel in a second direction, and the second direction is from the exit of the channel to the entrance of the channel; and instructions for the method further comprise:
instructions for obtaining a first speed and a second speed of the n-th mobile machine, and obtaining a second distance between the entrance of the channel and the exit of the channel, wherein the first speed is a movement speed of the n-th mobile machine outside the channel, and the second speed is a movement speed of the n-th mobile machine inside the channel; and
instructions for increasing the second cost based on the first speed, the second speed, the first distance, and the second distance, and taking the increased first cost as an updated second cost.

20. The storage medium of claim 19, wherein instructions for increasing the second cost based on the first speed, the second speed, the first distance, and the second distance comprise:
instructions for determining a ratio between the first speed and the second speed, and determining a product between the ratio and the second distance; and
instructions for determining a sum of the second cost, the first distance, and the product as the increased second cost.
